(19) United States
(12) Patent Application Publication
(10) Pub. No.: US 2011/0181961 A1
(43) Pub. Date: Jul. 28, 2011

(54) Mold, Method of Manufacturing Mold, Method of Manufacturing Wafer Lens, and Wafer Lens

(76) Inventor: Toshiyuki Imai, Tokyo (JP)

(21) Appl. No.: 13/121,292

(22) PCT Filed: Sep. 10, 2008
(86) PCT No.: PCT/JP2009/065814

§ 371 Date: Mar. 28, 2011

(30) Foreign Application Priority Data
Sep. 30, 2008 (JP) 2008-254434

(51) Int. Cl. G02B 3/00; B29C 33/38; B29D 11/00; B28B 7/24

(52) U.S. Cl. 359/642; 264/2.5; 264/2.6; 249/121

(57) ABSTRACT

Provided are a mold used to form a concave lens section and provided with a reference surface having improved flatness, a method of manufacturing the mold, a method of manufacturing a wafer lens by using the mold, and a wafer lens. The mold has one or more concave cavities formed in a base having a flat surface. A convex section is formed in each of the cavities, the convex section in the cavity is located below the surface of base (12).

### TECHNICAL FIELD

The present invention relates to a mold, a method of manufacturing a mold, a method of manufacturing a wafer lens, and a wafer lens.

### BACKGROUND ART

In the field of manufacturing optical lenses, conventionally, a technique for obtaining optical lenses with high heat resistance by arranging a lens section formed of curable resin on a glass substrate, has been studied (for example, Patent Literature 1). As an example of a method of manufacturing an optical lens to which such the technique is adapted, there has been suggested the following method: a so-called “wafer lens” formed by arranging plural lens sections made of curable resin on a surface of a glass substrate is prepared, and then, the glass substrate is cut to separate the lens sections.

### CITATION LIST

### Patent Literature

Patent literature 1: JP-B No. 3926380

### SUMMARY OF INVENTION

### Technical Problem

Incidentally, when the above optical lens or wafer lens is manufactured, a mold is used for molding a lens section made of resin. When a concave lens section is molded as a lens section, a convex section corresponding to that is required to be formed on a mold. When a convex section is formed in a mold, convex section 42 is normally formed by processing the whole surface of base 40 made of metal, as shown in FIG. 6. However, it is difficult to process a periphery of convex section 42 to be uniformly flat throughout the whole surface. In other words, it is difficult to form portion 44 excluding convex section 42 (a portion to be a reference surface of convex section 42) to be uniformly flat. Especially, when a mold for a wafer lens including plural concave lens sections is manufactured, respective convex sections 42 interrupt the operation of forming a flat surface and its difficulty furthermore increases.

Accordingly, a main object of the present invention is to provide a mold used for forming a concave lens section and configured to enhance a flatness of the reference surface. Another objects of the present invention are to provide a method of manufacturing the mold, a method of manufacturing a wafer lens by using the mold, and a wafer lens formed by the method.

### SOLUTION TO PROBLEM

To solve the above problems, an embodiment of the present invention provides a mold comprising a base with a flat surface, and one or plural concave cavities formed on the base. The mold is characterized in that a convex section is formed in each of the one or plural cavities, and the convex section of each of the one or plural cavities is located below the surface of the base.

According to another embodiment of the present invention, there is provided a method of manufacturing a mold comprising a base with a flat surface, and one or plural concave cavities are formed on the base. The method is characterized in that, when the one or plural cavities are formed, a convex section is formed in each of the one or plural cavities, and the convex section of each of the one or plural cavities is located below the surface of the base.

According to another embodiment of the present invention, there is provided a method of manufacturing a wafer lens with the above mold. The method is characterized by comprising: a step of dripping resin on the mold; a step of filling the one or plural cavities with the resin by pressing a glass substrate against the mold; a step of hardening the resin; and a step of releasing the resin together with the glass substrate from the mold.

According to another embodiment of the present invention, there is provided a wafer lens characterized by being manufactured by the above method of manufacturing a wafer lens.

### ADVANTAGEOUS EFFECTS OF INVENTION

According to the present invention, a convex section of each cavity is located lower than the surface of the base. Therefore, when cavities are formed on the base, it is enough to simply form concave cavities on the surface of the base without basically adding any processing to the surface of the base. Thereby, the surface of the base can be kept to be flat even after the cavities are formed. Further, under the assumption that the surface of the base is a reference surface, the flatness of the reference surface can be maintained in the original condition and the flatness of the reference surface can be further enhanced compared with conventional arts.

### BRIEF DESCRIPTION OF DRAWINGS

FIG. 1 is a perspective view illustrating a schematic structure of a wafer lens relating to the present example.

FIG. 2 is a diagram illustrating a schematic structure of a mold relating to the present example.

FIG. 3 is a cross-sectional view a part of FIG. 2.

FIG. 4 is a diagram for illustrating a method of manufacturing a mold and a method of manufacturing a wafer lens relating to the present example schematically.

FIGS. 5a and 5b are schematic diagrams for illustrating technical difference between the present example and the comparative example.

FIG. 6 is a schematic diagram for illustrating a conventional art and its problems.

FIGS. 7a and 7b are diagrams for illustrating an example of manufacturing a mold relating to the present example schematically, FIG. 7a is a diagram showing the whole construction and FIG. 7b is an extended diagram of a part of the diagram.

### DESCRIPTION OF EMBODIMENTS

Next, a preferable example of the present invention will be described below with referring to the drawings.

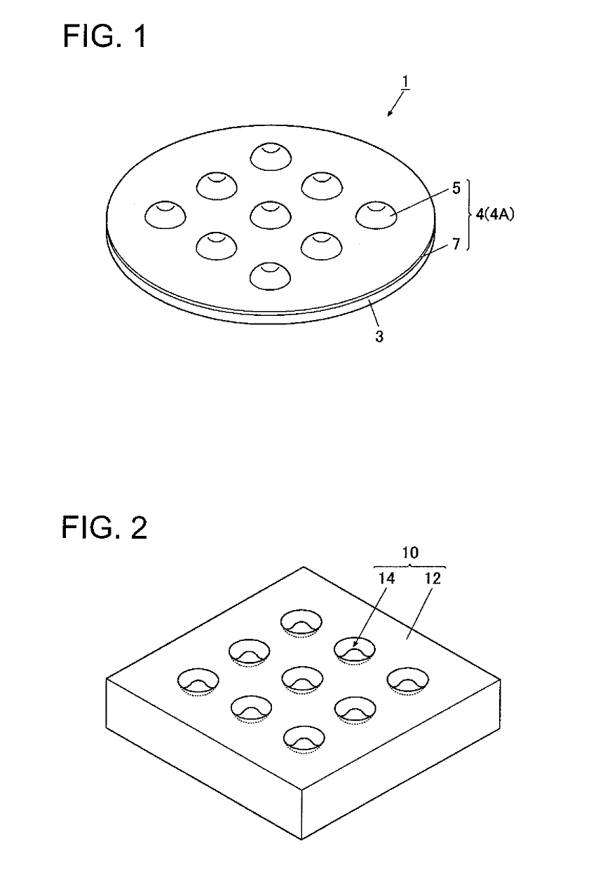

As shown in FIG. 1, wafer lens 1 is mainly composed of glass substrate 3 in a round shape and a resin section 4. Resin section 4 is a part made of resin and formed on the surface of glass substrate 3. The resin section has a structure that plural concave lens sections 5 are formed on flat-plate section 7, wherein each of the concave lens section protrudes from flat-plate section 7 and its center is formed to be concave. Concave lens sections 5 and flat-plate section 7 are formed to be one body and plural concave lens sections 5 are arrayed on flat-plate section 7. In each concave lens section 5, a fine structure such as diffractive grooves and steps may be formed.

Resin section 4 is made of resin 4A. Photo-curable resin or thermosetting resin is used as resin 4A.

As photo-curable resin, for example, acrylic resin or allyl-ester resin can be employed, and these resins can be reacted to be hardened by radical polymerization. As another photo-curable resin, for example, epoxy resin can be employed and the resin can be reacted to be hardened by cationic polymerization.

As thermosetting resin, for example, silicone resin can be used. The resin can be hardened by addition polymerization, additionally to the above radical polymerization or cationic polymerization.

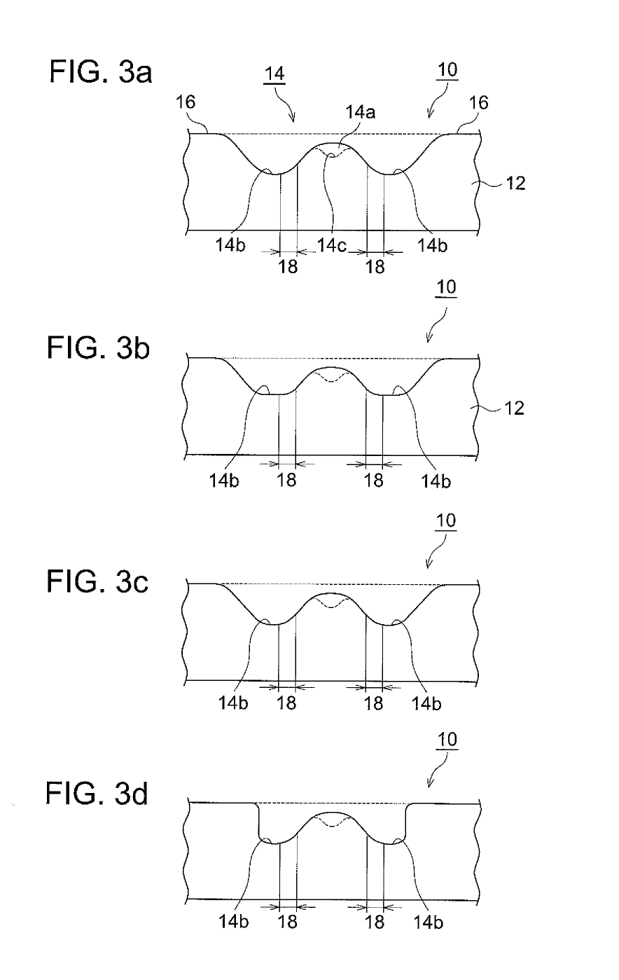

Next, a mold (10) used for manufacturing wafer lens 1, more concretely a mold used for molding concave lens section 5 of resin section 4, will be descried with referring to FIGS. 2 and 3.

As shown in FIG. 2, mold 10 includes base section 12 formed in a rectangular parallelepiped shape. In many cases, base section 12 is generally formed in a disk shape with a predetermined thickness and it can be used for the base section. A surface (top surface) of base section 12 is formed in a flat surface. On base section 12, plural concave cavities 14 are formed in array. Cavity 14 is a part corresponding to concave lens section 5 of wafer lens 1.

As shown in FIG. 3a, convex section 14a and concave section 14b are formed in each cavity 14. The center portion of cavity 14 protrudes upward to form convex section 14a, and its periphery is concaved to form concave section 14b. Further, the center portion of the convex section 14a and a part of an area between the center portion of convex section 14a and connecting section 18 may be concaved. Concave section 14c may be formed in the center portion of convex section 14a as illustrated by a middle dotted line. An area that is the surface of base section 12 and is a surface between cavities 14 is flat, and it becomes reference surface 16 used when cavities 14 are formed on base section 12. Reference surface 16 is formed in a plat surface.

Herein, convex section 14a in cavity 14 is a part corresponding to an optical surface where effective rays passes through in concave lens section 5.

The highest portion of convex section 14a of cavity 14 is located at a position which is lower than reference surface 16. Connecting section 18 extending from convex section 14a to concave section 14b forms a smoothly-curved shape. When observing the cross section of cavity 14, connecting section 18 may have a shape such that plural arcs with different curvatures from each other are connected together, a shape of straight line formed by extending a tangential line of a line which falls from convex section 14a toward concave section 14b, or a shape of straight line formed by extending a line which inclines greater than the tangential line.

In FIG. 3a, the bottom portion of concave section 14b forms a curved shape which is convex downward. However, the bottom portion may be formed to be flat (see FIG. 3b). When the bottom portion is formed to be flat like this, connecting section 18 is preferably fanned to be an arc shape which smoothly connects to the flat surface. Further, the surface connecting the bottom portion of concave section 14b to reference surface 16 may be formed in a tapered shape (see FIG. 3c), or the surface connecting the bottom portion of concave section 14b to reference surface 16 may be formed in a cylinder shape (see FIG. 3d).

In mold 10, reference surface 16 of base section 12 and convex section 14a of cavity 14 are mirror-polished, and concave section 14b of cavity 14 and connecting section 18 are made rough. When concave section 14c is formed in cavity 14, concave section 14c is also mirror-polished. In the present invention, “be mirror-polished” means the condition that Ra (surface roughness) is 10 nm or less, and “be made rough (forms to be rough)” means the condition that the value of Ra excesses 10 nm.

In cavity 14, a part of connection section 18 may be mirror-polished additionally to convex section 14a (in this case, the rest part of connecting section 18 and the whole of concave section 14b are made rough), the whole of connecting section 18 may be mirror-polished (in this case, the whole of concave section 14b is made rough), the whole of connecting section 18 and a part of concave section 14b may be mirror-polished (in this case, the rest part of concave section 14b is made rough), or the whole of connecting section 18 and the whole of concave section 14b may be mirror-polished.

Mold 10 is formed of metal, metallic glass, or amorphous alloy.

As corresponding metals, there can be cited ferrous materials and other alloys.

As ferrous materials, the followings are cited: hot work die steels, cold work die steels, steels for plastic molding, high speed tool steels, rolled steels for general structures, carbon steels for machine structures, chromium molybdenum steels, and stainless steels. Among them, there are cited as steels for plastic molding, prehardened steels, steels for quenching and tempering, and steels for aging. As prehardened steels, there are cited SC types, SCM types, and SUS types. More concretely, SC types involve PXZ. As the SCM types, there are cited HPM2, HPM7, PX5, and IMPAX. As the SUS types, there are cited HPM38, HPM77, S-STAR, G-STAR, STAVAX, RAMAX-S, and PSL.

As ferrous alloys, the followings are cited materials disclosed in JP-A Nos. 2005-113161 and 2005-206913. As nonferrous alloys, there are well known copper alloys, aluminium alloys, and zinc alloys. For example, there are cited alloys disclosed in JP-A Nos. H10-219373, and 2000-176970.

As metallic glass, PdCuSi and PdCuSiNi are suitable, because their machinabilities under diamond turning are high, which reduces wear of tools. Further, amorphous alloys such as a material for nonelectrolytic or electrolytic nickel phosphorus plating are also suitable, because their machinabilities under diamond turning are excellent. Those high machinability materials may form the whole of mold 10 or may cover only the surface of an optical transfer surface by plating or sputtering the materials thereon.

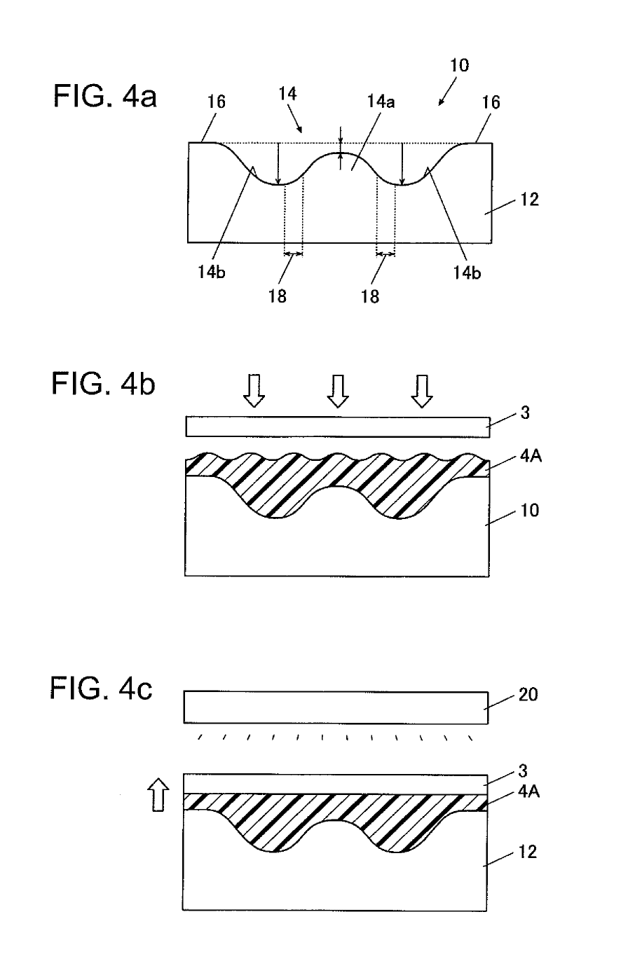

Next, a method of manufacturing mold 10 and a method of manufacturing wafer lens 1 by using mold 10 will be described with referring to FIG. 4.

After a proper material which can be used for mold 10 is selected, a surface of base section 12 thereof, which is referred as reference surface (16), is processed by machine work such as cutting and grinding, as shown in FIG. 4a, to form concave cavities 14. In this case, the material is processed such that convex section 14a of each of cavities 14 is located under reference surface 16 and connecting section 18 extending from convex section 14a to concave section 14b forms a curved shape.

After that, the whole surface of the inside of each of cavities 14 is made rough. Then, reference surface 16 and convex section 14a of each of cavities 14 are mirror-polished by processing the reference surface 16 and convex section 14a of each of cavities 14 to be mirror surfaces. Herein, processing of mirror surfaces is not applied especially to concave section 14b and connecting section 18 of each of cavities 14, and concave section 14b and connecting section 18 of each of cavities 14 remain rough. By the above processing, mold 10 is manufactured.

After that, a predetermined amount of resin 4A is dripped on mold 10, and glass substrate 3 is pressed from the top As the result, cavities 14 of mold 10 are filled with resin 4A, as shown in FIG. 4b.

After that, if resin 4A is photo-curable resin, as shown in FIG. 4c, light source 20 arranged over glass substrate 3 lights up and resin 4A is irradiated through glass substrate 3, to harden resin 4A. On the other hand, if resin 4A is thermosetting resin, resin 4A is heated to be hardened.

After that, hardened resin 4A is released together with glass substrate 3 from mold 10. As the result, wafer lens 1 on which plural concave lens sections 5 and flat-plate section 7 are formed on glass substrate 3 is manufactured.

The above example exhibits the following actions and effects.

(1) Concave section 14a of each of cavities 14 is located at a lower position than that of reference surface 16. Therefore, when cavities 14 are formed on base section 12, any processing is not basically required for the surface of base section 12 and it is enough to just form concave cavities 14 on the surface. Therefore, the surface of base section 12 is kept to be flat even after cavities are formed thereon, which enhances the flatness of reference surface 16 better than that of a conventional lens.

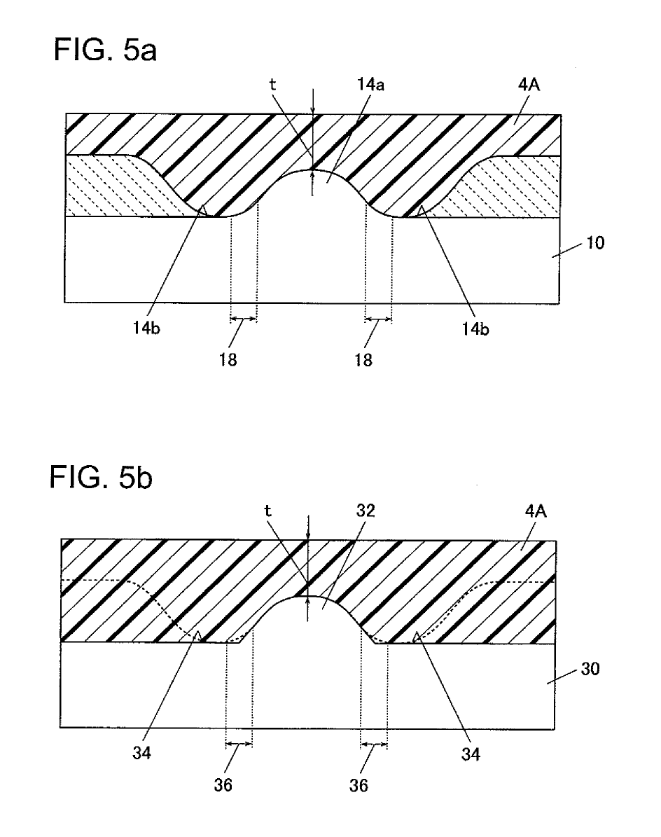

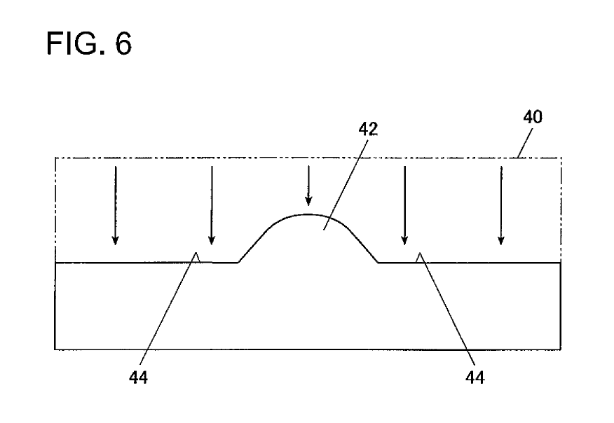

(2) As for molding concave section 5 of wafer lens 1, when concave lens sections are tried to be formed such that their shapes and the center thicknesses of resins A4 are same to each other under the following conditions: the condition that convex section 14a and concave section 14b are formed in cavity 14 of mold 10 shown in FIG. 5a (the present example), and the condition that convex section 32 is formed simply on a surface of mold 30 shown in FIG. 5b (a comparative example), an amount of filled resin 4A reduces by an amount represented by dotted lines in the present example shown in FIG. 5a. Therefore, the amount of resin 4A to be used for molding process can be saved, which realizes saving the cost of the resin material.

(3) As for forming cavity 14 on base section 12, when comparing the condition that convex section 14a and concave section 14b are formed in cavity 14 of mold 10 shown in FIG. 5a (the present example), and the condition that convex section 32 is simply formed on a surface of mold 30 shown in FIG. 5b (a comparative example), connecting section 36 extending from convex section 32 to reference surface 34 is bent in the comparative example, which makes a possibility that light entering the bent section becomes a point light source and that ghost and flare light are generated.

On the other hand, in the present example shown in FIG. 5a, connecting section 36 extending from convex section 32 to reference surface 34 forms a smoothly-curved shape, which can control a generation of ghost in concave lens section 5 formed from mold 10. Additionally, in the present example, convex section 14a of each of cavities 14 of mold 10 and reference surface 16 are mirror-polished especially and concave section 14b of each of cavities 14 is kept as they are made rough. Thereby, a part which forms concave lens section 5 molded from mold 10 and corresponds to concave section 14b can scatter light to directly enter a sensor, which controls the generation of ghost more excellently.

(4) For processing mold 10 to be mirror-polished, reference surface 16 is specially processed to be mirror-polished, additionally to convex section 14a of each of cavities 14. Thereby, a transferred section of resin 4A which is transferred from the reference surface becomes smooth. Herein, when plural wafer lenses 1 are layered with spacers arranged between them, each spacer directly touches with the transferred section, which aims to uniform the degree of parallelization (interval) of spacers and allows the degree of parallelization (interval) of spacers being kept to be uniform.

In the present expression, mold 10 including two or more cavities 14 and wafer lens 1 manufactured by the mold are described. However, mold 10 may includes just one cavity 14. In this case, the way to form cavity 14 is the same to that described above. Further, one concave lens section 5 may be molded from mold 10 including one cavity 14, to serve wafer lens 1.

### EXAMPLES

An example of processing of a mold (a method of manufacturing a mold) relating to the present invention will be described.

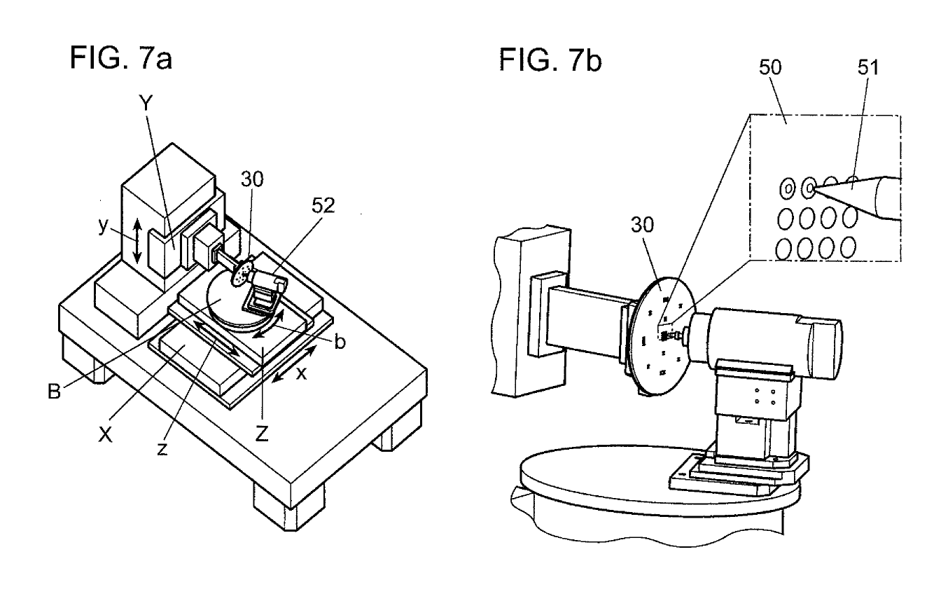

Mold 30 including optical surfaces 50 which are arranged in an array as shown FIG. 7b has been processed.

Optical surface 50 has been processed in an ultra precision processing machine shown in FIG. 7a, with ball-end-mill tool 51. As shown in FIG. 7a, X-axis stage X for being driven in X-axis direction x and Y-axis stage Y for being driven in Y-axis direction y are mounted on a surface plate. On X-axis stage X, Z-axis stage Z for being driven in Z-axis direction z is mounted. On the Z-axis stage Z, B-axis pivot shaft B for turning in direction b is mounted. Tool spindle 52 for rotating ball-end-mill tool 51 is fixed on B-axis pivot shaft B.

Ball-end-mill tool 51 used for cutting is formed of single crystal diamond, its rake face at the tip inclines at 70°, and the tip is formed in a semicircular shape. The tip of the rake face of the cutting edge is formed in an arc with a radius of 0.3 mm, and the clearance angle is 10°. The cutting depth in this case, is 2 μm. For a material of the mold surface forming a shape of an optical surface, a material for electroless nickel plating, which is amorphous alloy, has been employed.

In the present mold, an aspheric optical surface does not protrude above the reference flat surface, even if the aspheric optical surface has a convex shape, which enables that the reference flat surface is processed to be mirror-polished in short time. In the present example, mirror-polishing process has been carried out with a tool formed of single crystal diamond in an ultra-precision lathe, and it has been processed with surface roughness Ra of 2.6 nm.

When mirror-polishing a mold to form an aspheric optical surface shape, the processing is carried out by controlling the four shafts of shafts X, Y, Z, and B at the same time, such that the working area of the cutting edge of the tool becomes as narrow as possible. Thereby, deterioration of accuracy of processed shape caused by a shape error of the tool has been minimized. As the result, the accuracy in shape of a processed surface after a processing for shape correction is carried out once, became PV 100 nm or less, which satisfied desired accuracy.

When the processed surface was measured in terms of roughness of its optical surface by using a surface-roughness-measuring instrument HD3300 made by WYKO Inc., the average surface roughness Ra became 3.3 nm and an excellent optical mirror surface is obtained. Further, when the surface is observed by a differential interference microscope, there have not been observed chatter marks of the tools on the processed surface.

On the other hand, the concave section for which mirror-polishing has not been carried out, kept its surface as electroless nickel plating were deposited thereon, and its surface roughness Ra was 37 nm, which was made sufficiently rough.

When ghost of lenses molded from the conventional mold and the mold of the present invention were simulated, it results in that the mold of the present invention provided weaker ghost intensity. When comparing images shot by a lens unit composed of a lens molded by the conventional mold and a lens unit composed of a lens molded by the mold of the present invention, it was confirmed that the lens unit employing a lens molded by the mold of the present invention exhibited smaller ghost.

For the processing of the aspheric optical surface, shaper processing with a stationary tool may be employed. The processing machine for use in the shaper processing may be selected from proper machines such as 3-axes controlled processing machine in terms of X, Y, and Z axes.

### REFERENCE SIGNS LIST

1 Wafer lens
3 Glass substrate
4 Resin section
4A Resin
5 Concave lens section
7 Flat-plate section
10 Mold
12 Base section
14 Cavity
14a Convex section
14b Concave section
16 Reference surface
18 Connecting section
20 Light source
30 Mold
32 Convex section
34 Reference surface
36 Connecting section

1. A mold for molding an optical element, comprising a base with a flat surface, and one or plural concave cavities formed on the base,
wherein a convex section is formed in each of the one or plural cavities, and
the convex section of each of the one or plural cavities is located below the surface of the base and has a shape corresponding to an optical surface of the optical element.

2. The mold of claim 1,
wherein a concave section is formed at a periphery of the convex section of each of the one or plural cavities, and
a connecting section formed between the concave section and the convex section of each of the one or plural cavities forms a curved shape.

3. The mold of claim 1,
wherein the surface of the base and the convex section of each of the one or plural cavities are mirror-polished,
a part or whole of the concave section of each of the one or plural cavities is mirror-polished, and
a rest part is made rough.

4. A method of manufacturing a mold for molding an optical element, the mold comprising a base with a flat surface, and one or plural concave cavities are formed on the base,
wherein when the one or plural cavities are formed, a convex section is formed in each of the one or plural cavities, and the convex section of each of the one or plural cavities is located below the surface of the base and has a shape corresponding to an optical surface of the optical element.

5. The method of manufacturing a mold of claim 4,
wherein when the one or plural cavities are formed, a concave section is formed at a periphery of the convex section of each of the one or plural cavities, and
a connecting section formed between the concave section and the convex section of each of the one or plural cavities forms a curved shape.

6. The method of manufacturing a mold of claim 4,
wherein after the one or plural cavities are formed, the surface of the base and the one or plural cavities are made rough, and then,
the surface of the base and the convex section of each of the one or plural cavities are mirror-polished.

7. A method of manufacturing a wafer lens with the mold of claim 1, the method by comprising:
a step of dripping resin on the mold;
a step of filling the one or plural cavities with the resin by pressing a glass substrate against the mold;
a step of hardening the resin; and
a step of releasing the resin together with the glass substrate from the mold.

8. A wafer lens being manufactured by the method of manufacturing a wafer lens of claim 7.
